(19) United States
(12) Patent Application Publication
(10) Pub. No.: US 2017/0306899 A1
(43) Pub. Date: Oct. 26, 2017

(54) EXHAUST CIRCULATING DEVICE FOR INTERNAL COMBUSTION ENGINE

(71) Applicant: DENSO CORPORATION, Kariya-city, Aichi-pref. (JP)

(72) Inventors: Yoshihisa SANAMI, Kariya-city (JP); Hideaki ICHIHARA, Kariya-city (JP); Keitarou MINAMI, Kariya-city (JP)

(73) Assignee: DENSO CORPORATION, Kariya-City, Aichi-Pref. (JP)

(21) Appl. No.: 15/526,069

(22) PCT Filed: Nov. 16, 2015
(86) PCT No.: PCT/JP2015/005700

§ 371 Date: May 11, 2017

(30) Foreign Application Priority Data
Nov. 20, 2014 (JP) 2014-235731
Oct. 9, 2015 (JP) 2015-201041

(51) Int. Cl. F02M 26/34; F02M 26/17; F02M 26/06

(52) U.S. Cl. CPC F02M 26/34; F02M 26/06; F02M 26/17

(57) ABSTRACT

An ejector used in an EGR system is disposed at a position at which at least part of an outer-diameter-gradually-varying portion of a nozzle can be viewed through an introduction hole from the outside of the housing. Consequently, EGR gas introduced into the housing through the introduction hole is introduced into a decompression chamber without colliding with an outer wall of an outer-diameter equivalent portion of the nozzle. The outer-diameter-gradually-varying portion of the nozzle guides the EGR gas from the introduction hole, so that the EGR gas can be efficiently mixed with an air flow of compressed air supplied from an air compressor.

### CROSS-REFERENCE TO RELATED APPLICATION

This application is based on Japanese Patent Applications No. 2014-235731 filed on Nov. 20, 2014 and No. 2015-201041 filed on Oct. 9, 2015, the disclosures of which are incorporated herein by reference.

### Technical Field

The present disclosure relates to an exhaust circulating device, and specifically relates to an exhaust circulating device that recycles some of exhaust air as EGR gas to an intake system, the exhaust air being exhausted from a cylinder of an internal combustion engine.

### BACKGROUND ART

### Prior Art

In a previously disclosed EGR system, some of exhaust air, which is exhausted from a cylinder of an internal combustion engine, is recycled as EGR gas to an intake system, and is mixed into intake air (fresh air) passing through an air cleaner to lower combustion temperature, so that the amount of nitrogen oxide (NOx) is decreased (for example, see Patent Literature 1 and Patent Literature 2).

Patent Literature 1 describes “low-pressure loop EGR system”. The EGR system has an EGR channel that communicates between an exhaust path downstream of a turbine of a turbo charger and an intake path upstream of a compressor.

An exit of the EGR channel is connected to the intake path through which intake air flows after passing through the air cleaner. The intake path is structured so as to be bifurcated at a bifurcation into first and second channels that meet again at a junction upstream of the compressor. The first channel is connected to an exit of the EGR channel. An ejector including a nozzle, a diffuser, and a decompression chamber is provided between the first channel and the EGR channel.

When the ejector has an inlet pressure higher than outlet pressure, fresh air flowing through the first channel is ejected from the nozzle to the diffuser, and thus negative pressure is generated within the decompression chamber, and an EGR gas is drawn from the EGR channel into the decompression chamber, the diffuser, and the first channel.

The second channel has an intake throttle valve. A decrease in valve opening of the intake throttle valve generates negative pressure at a joint between the first and second channels, and thus prompts return of the EGR gas into the intake path. Such a configuration can increase the upper limit of the amount of EGR gas, and exhibits an effect of improving fuel consumption.

Patent Literature 2 describes a configuration in which an ejector drawing the EGR gas is disposed in an intake path downstream of a compressor.

The ejector is integrally-molded with a casing having a connection for an ECR channel. The casing internally has a cylindrical throat portion, which is reduced in diameter toward the downstream and has an open end opened toward a joint chamber of the casing. The joint chamber is in communication with an EGR introduction hole provided in the connection.

A throttle portion is provided in the inside of the joint chamber. This allows the EGR gas to be introduced from the EGR introduction hole into a flow right below the open end of the throat portion of the ejector. The EGR gas is thus introduced into the throttle portion downstream of the throat portion, and is promptly sent toward an intake manifold while being mixed with the EGR gas in the throttle portion.

In the EGR system of Patent Literature 1, however, since the ejector is disposed in the intake path upstream of the compressor, inlet pressure of the ejector cannot be increased to the atmospheric pressure or higher. Consequently, the amount of the EGR gas, which is drawn into the intake path by the ejector effect, may not arrive at a desired level. Specifically, the upper limit of the amount of the EGR gas cannot be increased to an expected level, which may limit contribution to the effect of improving fuel consumption.

In the EGR system of Patent Literature 2, channel cross section of the EGR channel, into which the EGR gas is introduced through the EGR introduction hole, gradually decreases, and when the EGR gas flows through the channel having the smallest cross section between the periphery of the throat portion of the ejector and the inner wall of the casing, pressure loss in the EGR gas flow may increase.

When the EGR gas flow meets an air flow of the compressed air, separation or vortex occurs in the EGR gas flow at a peripheral edge of the throat portion of the ejector because a downstream end of the throat portion has a right angle. Consequently, pressure loss in the EGR gas flow may increase.

### PRIOR ART LITERATURES

### Patent Literature

Patent Literature 1: JP 2013-002377 A

Patent Literature 2: JP 2005-147010 A

### SUMMARY OF INVENTION

An object of the present disclosure is to provide an exhaust circulating device for an internal combustion engine, which can draw a larger amount of EGR gas. Another object of the disclosure is to provide an exhaust circulating device for an internal combustion engine, which can reduce pressure loss in an EGR gas flow.

According to an embodiment of the disclosure, an end portion of a nozzle is disposed in an insertional manner within a negative-pressure generation chamber of an ejector. Provided is an air compressor that compresses air containing at least outside air to generate compressed air, and supplies the compressed air to the nozzle. In other words, the ejector is provided in an intake path downstream of the air compressor.

This allows the compressed air having the atmospheric pressure or higher to be supplied from the air compressor to the ejector, thereby inlet pressure of the nozzle can be increased to an air pressure equal to or higher than the atmospheric pressure.

Negative pressure is generated in a negative-pressure generation chamber by an air flow of the compressed air ejected from an end opening of the nozzle into the negative-pressure generation chamber. The negative pressure allows the EGR gas to be drawn through an introduction hole of the ejector. The ejector supplies the EGR gas drawn into the negative-pressure generation chamber to an internal combustion engine while mixing the EGR gas with the air flow ejected from the end opening of the nozzle into the negative-pressure generation chamber.

Consequently, the amount of EGR gas, which is drawn into the intake path through an EGR channel by the ejector effect, is increased to a desired level or more.

Since a larger amount of EGR gas can be drawn from the EGR channel into the intake path, the upper limit of the amount of the EGR gas can be increased. Consequently, large contribution to the effect of improving fuel consumption can be expected.

The nozzle has an outer-diameter-gradually-varying portion having an outer diameter that gradually decreases from a starting point to an end peripheral edge. The outer-diameter-gradually-varying portion of the nozzle is disposed at a position allowing at least partial view thereof through the introduction hole from the outside of the ejector. The position allowing at least partial view through the introduction hole from the outside of the ejector refers to a position allowing at least part of the outer-diameter-gradually-varying portion of the nozzle to be viewed when the inside (nozzle) of the ejector is viewed through the introduction hole from the outside (an outer side in a radial direction of the nozzle) of the ejector.

Consequently, the EGR gas introduced from the introduction hole into the ejector is introduced into the negative-pressure generation chamber without colliding with the outer wall of the nozzle. The outer-diameter-gradually-varying portion guides the EGR gas from the introduction hole, and thus the EGR gas can be efficiently mixed with the air flow of the compressed air supplied from the air compressor.

It is therefore possible to reduce pressure loss or stagnation in the EGR gas flow due to collision with the outer wall of the nozzle.

### BRIEF DESCRIPTION OF DRAWINGS

The above-described object, other objects, features, and advantages of the disclosure will be further clarified from the following detailed description with reference to the accompanying drawings.

FIG. 1 is a configuration diagram illustrating a schematic configuration of a control system of an internal combustion engine (first embodiment).

FIG. 2 is a front view illustrating an ejector and an EGR pipe (first embodiment).

FIG. 3 is a sectional view along III-Ill in FIG. 2 (first embodiment).

FIG. 4 is a plan view illustrating the ejector and the EGR pipe (first embodiment).

FIG. 5 is a sectional view illustrating the ejector (first embodiment).

FIG. 6 includes schematic views illustrating flow of each of an EGR gas and compressed air in the ejector (first embodiment).

FIG. 7 is an explanatory view illustrating EGR rate when a position of a starting point A is varied with respect to an introduction-hole wall surface B (first embodiment, comparative example 1, and comparative example 2).

FIG. 8 is a configuration diagram illustrating a schematic configuration of an engine control system (second embodiment).

### EMBODIMENT FOR CARRYING OUT INVENTION

Embodiments for carrying out the invention are now described with reference to drawings.

### Configuration of First Embodiment

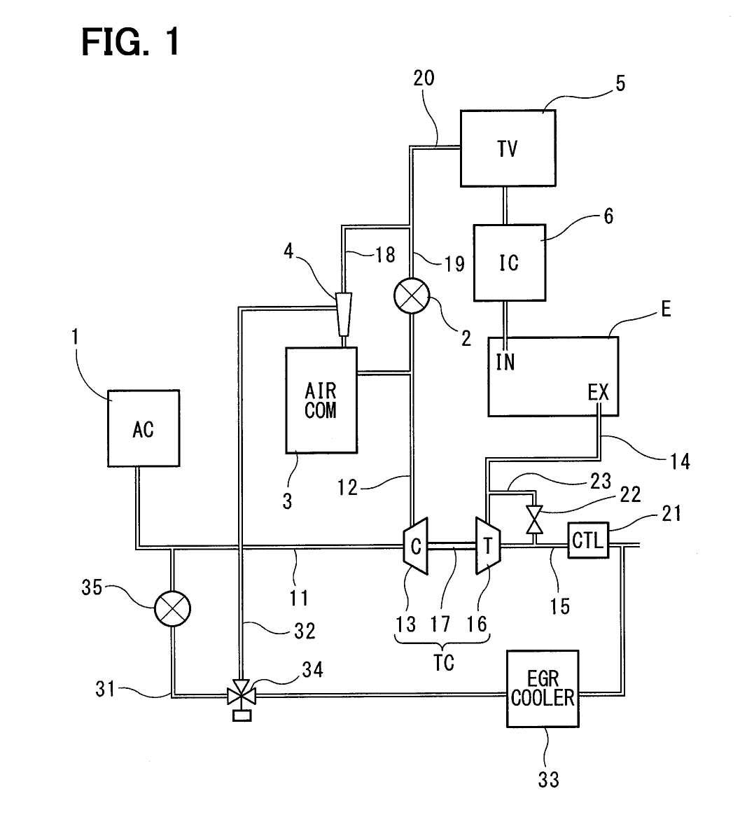

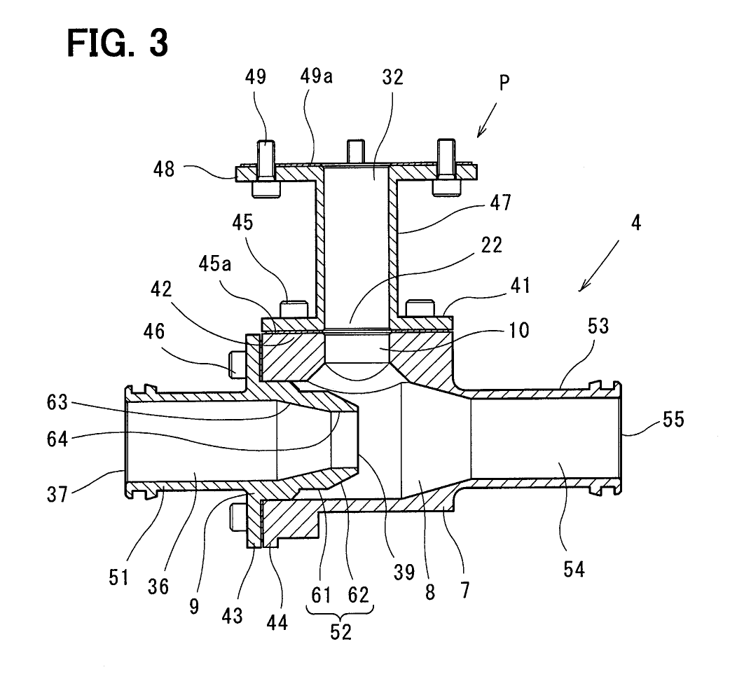

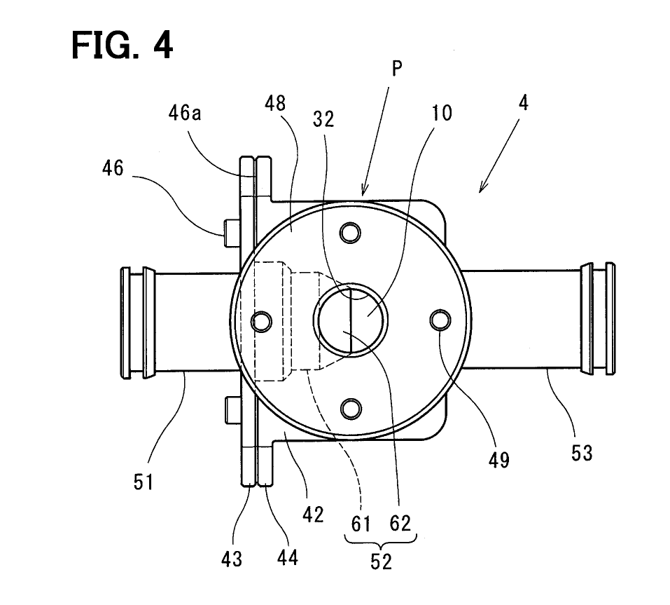

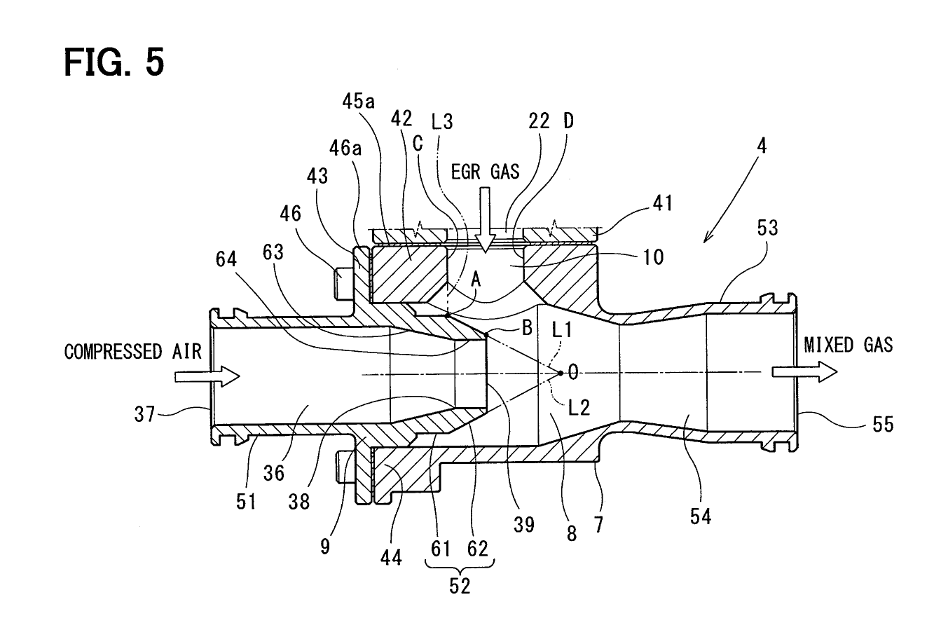

FIGS. 1 to 7 illustrate a first embodiment to which the disclosure is applied.

An engine control system of the first embodiment includes an air cleaner 1, a turbo charger TC, a bypass valve 2, an air compressor 3, an ejector 4, a throttle valve 5, an intercooler 6, an exhaust circulating device (hereinafter EGR system), and an engine control unit (electronic control unit, hereinafter ECU).

The ejector 4 of the first embodiment is provided in an intake path of an engine E. The ejector 4 includes a cylindrical housing 7 to be connected to an EGR pipe P, a circular tube nozzle 9 that ejects compressed air into a negative-pressure generation chamber (hereinafter decompression chamber 8) of the housing 7, and the like.

The air cleaner 1 includes an element that filters a foreign substance contained in fresh air (outside air) from the outside. The air cleaner 1 is provided in an intake path 11 upstream of a compressor 13.

The turbo charger TC includes the compressor 13 provided between intake paths 11 and 12 for the engine E, and a turbine 16 provided between exhaust paths 14 and 15 for the engine E.

The compressor 13 compresses air flowing through an undepicted intake channel that communicates between the intake paths 11 and 12, and supplies the compressed air to a cylinder of the engine E.

The turbine 16 is connected to the compressor 13 via a turbine shaft 17 in an integrally rotatable manner. The turbine 16 is rotationally driven by pressure and flow rate of exhaust air flowing through an undepicted exhaust channel that communicates between the exhaust paths 14 and 15.

When the turbine 16 is rotationally driven, the compressor 13 connected to the turbine 16 via the turbine shaft 17 is also rotated. When the compressor 13 is rotated, the compressor 13 compresses air passing through the intake channel.

The air cleaner 1, the compressor 13, the bypass valve 2, the air compressor 3, the ejector 4, the throttle valve 5, the intercooler 6, and the like are provided in the intake pipe to be connected to a bifurcation of an intake manifold of the engine E.

The intake path 12 downstream of the compressor 13 is bifurcated into first and second intake paths (channels 18 and 19) at a bifurcation. The channels 18 and 19 meat at a joint upstream of the throttle valve 5, and communicate with an intake path 20 upstream of the intake manifold.

The throttle valve 5 configures a valve body of an intake throttle valve. The throttle valve 5 is subjected to switching (rotation) drive by an electromotive actuator such as a motor or a mechanical actuator. The actuator has a built-in throttle opening sensor that detects throttle opening corresponding to a rotation angle of the throttle valve 5.

The opening of the throttle valve 5 is controlled through current application by the ECU. This leads to adjustment of flow rate of compressed air (intake air) flowing through the intake path 20 that communicates with the cylinder of the engine E.

The intercooler 6 is a cooling heat exchanger to cool the compressed air, the temperature of which is increased through compression by the compressor 13 or the air compressor 3, with a cooling medium such as cooling water. This makes it possible to improve filling efficiency of intake air supplied to the cylinder of the engine E.

The bypass valve 2, the air compressor 3, the ejector 4, and the channels 18 and 19 are described in detail later.

The turbine 16, an exhaust emission control device (a catalyst such as a three-way catalyst, hereinafter catalyst) 21, a waste gate valve 22, and an undepicted muffler are provided in an exhaust pipe to be connected to a gathering portion of an exhaust manifold of the engine E.

The catalyst 21 purges components such as CO, HC, and NOx in exhaust air flowing through the exhaust path 15. A diesel particulate filter (DPF), an oxidation catalyst (DOC), or a NOx catalyst may be used as the exhaust emission control device in place of the three-way catalyst. Alternatively, two or more of them may be disposed in series.

The waste gate valve 22 is provided in a waste gate channel 23 that communicates between the exhaust path 14 and the exhaust path 15 while bypassing the turbine 16. The waste gate valve 22 is an exhaust-flow-rate control valve. The waste gate valve 22 is also a boost pressure control valve that is opened to allow the exhaust air, which is exhausted from the cylinder of the engine E, to bypass the turbine 16 when boost pressure of the compressor 13 exceeds a set point.

The opening of the waste gate valve 22 is controlled through current application by the ECU. This allows adjustment of flow rate of the exhaust air flowing through the waste gate channel 23. Consequently, boost pressure can be reduced during opening of the waste gate valve 22.

The EGR system includes “low-pressure loop (LPL)-EGR system”.

The EGR system includes first and second EGR channels 31 and 32, an EGR cooler 33, a channel switching valve 34, an EGR valve 35, and the like.

The first EGR channel 31 communicates between the exhaust path 15 downstream of the turbine 16 (downstream of the catalyst 21 in the first embodiment) and the intake path 11 upstream of the compressor 13.

The second EGR channel 32 communicates between the exhaust path 15 downstream of the turbine 16 and an introduction hole (as described later) of the ejector 4 provided in the channel 18 downstream of the compressor 13.

The EGR cooler 33 is disposed in a common channel of the first and second EGR channels 31 and 32, i.e., an EGR channel upstream of the channel switching valve 34. The EGR cooler 33 is a heat exchanger that cools the EGR gas, which is introduced from the exhaust path 15 downstream of the turbine 16, with a cooling medium such as cooling water.

The channel switching valve 34 is provided at a bifurcation for the first and second EGR channels 31 and 32. The channel switching valve 34 is a two-position three-direction switching valve that selectively switches between the first EGR channel 31 and the second EGR channel 32.

The switching position of the channel switching valve 34 is controlled through current application by the ECU. The channel switching valve 34 is driven and switched by an electromotive actuator such as a motor.

When the channel switching valve 34 is closed, the EGR channel is switched to the first EGR channel 31. When the channel switching valve 34 is opened, the EGR channel is switched to the second EGR channel 32.

The EGR valve 35 is provided in the first EGR channel 31 downstream of the channel switching valve 34. The EGR valve 35 is driven and switched (rotationally driven) by an electromotive actuator such as a motor. The actuator has a built-in EGR opening sensor that detects an EGR opening corresponding to a rotation angle of the EGR valve 35.

The opening of the EGR valve 35 is controlled through current application by the ECU. This allows adjustment of flow rate of the EGR gas flowing through the first EGR channel 31.

The bypass valve 2 and the channels 18 and 19 of the first embodiment are now described in detail with reference to FIGS. 1 to 7.

The bypass valve 2 is provided in the middle of the channel 19. The bypass valve 2 is driven and switched by an electromotive actuator such as a motor.

The opening of the bypass valve 2 is controlled through current application by the ECU. This allows adjustment of flow rate of the air flow that bypasses the channel 18. Consequently, flow rate of the EGR gas drawn by the ejector 4 can be adjusted.

The channel 18 is disposed in parallel with the channel 19. The channel 18 communicates between the intake path 12 downstream of the compressor 13 and the intake path 20 for the engine E.

The channel 19 communicates between the intake path 12 downstream of the compressor 13 and the intake path 20 for the engine E without passing through the air compressor 3 and the ejector 4.

The air compressor 3 of the first embodiment is now described in detail with reference to FIG. 1.

The air compressor 3 is provided in the channel 18 downstream of the compressor 13 and upstream of the ejector 4.

The air compressor 3 is composed of an electromotive charger (for example, an electromotive super charger or an electromotive compressor). The air compressor 3 compresses air supplied from the compressor 13 to generate compressed air, and supplies the compressed air to the nozzle 9.

The compressed air generated by the air compressor 3 is supplied to the ejector 4. The air compressor 3 is rotationally driven by an electromotive actuator such as a motor. The actuator is controlled through current application by the ECU.

The ECU has a built-in microcomputer having a known structure including functions of CPU, memories (ROM, RAM), a motor drive circuit, a valve drive circuit, and the like.

The microcomputer is connected to sensors such as an accelerator opening sensor that detects a depressing amount of an accelerator pedal by a driver.

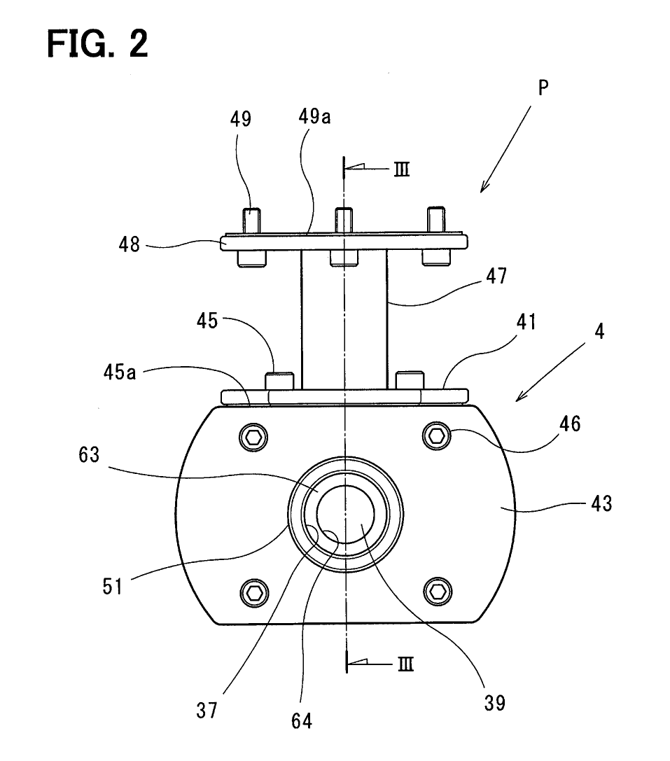

The ejector 4 of the first embodiment is now described in detail with reference to FIGS. 1 and 2.

The ejector 4 is provided in the channel 18 downstream of the air compressor 3. The ejector 4 includes the cylindrical housing 7 to be connected to the EGR pipe P forming the second EGR channel 32, and the nozzle 9, which ejects an air flow of the compressed air, in the decompression chamber 8 provided in the housing 7.

The ejector 4 uses negative pressure, which is generated by the air flow of the compressed air ejected from the nozzle 9 into the decompression chamber 8, to draw a large amount of EGR gas into the decompression chamber 8 through an EGR gas introduction hole (hereinafter, introduction hole 10). The EGR gas drawn into the decompression chamber 8 is mixed with the air flow of the compressed air ejected from the nozzle 9 into the decompression chamber 8, and is then supplied to the cylinder of the engine E.

The nozzle 9 internally has a nozzle orifice 36 that introduces the compressed air from the air compressor 3, and ejects an air flow of the compressed air to the decompression chamber 8. The nozzle orifice 36 forms an airflow path that directly extends in an axial direction of the nozzle 9. The nozzle orifice 36 includes an inlet opening 37, a throttle portion 38, and an end opening 39.

The inlet opening 37 is provided at an open end on the upstream side of the nozzle orifice 36. The inlet opening 37 is opened toward the outside of the nozzle 9. The inlet opening 37 serves as an intake that takes the compressed air compressed by the air compressor 3 into the ejector 4.

The throttle portion 38 has a reduced channel cross section of the nozzle orifice 36 to decompress the compressed air flowing through the nozzle orifice 36 for conversion from static pressure to dynamic pressure.

The end opening 39 is provided at an open end on the downstream side of the nozzle orifice 36. The end opening 39 is opened toward the outside of the nozzle 9. The end opening 39 is a jet that ejects the air flow of the compressed air to the decompression chamber 8.

The housing 7 has an EGR pipe connection 42 for connection of a coupling flange 41 of the EGR pipe P, and an intake pipe connection 44 for connection of a coupling flange 43 of the nozzle 9.

A gasket 45a is sandwiched between the coupling flange 41 and the EGR pipe connection 42. The coupling flange 41 is fastened to the EGR pipe connection 42 by a plurality of bolts 45.

The coupling flange 43 is associated with a gasket 46a sandwiched between the coupling flange 43 and the intake pipe connection 44. The coupling flange 43 is fastened to the intake pipe connection 44 by a plurality of bolts 46.

The EGR pipe P has a straight pipe portion 47 the inside of which forms the second EGR channel 32. The coupling flange 41 to be connected to the housing 7 is provided at a downstream end of the straight pipe portion 47. A coupling flange 48 to be connected to the channel switching valve 34 is provided at an upstream end of the straight pipe portion 47. The coupling flange 48 is fastened to an undepicted EGR pipe connection of the channel switching valve 34 by a plurality of bolts 49. A gasket 49a is sandwiched between the coupling flange 48 and the EGR pipe connection of the channel switching valve 34.

An EGR pipe structured separately from the EGR pipe P may be connected between the channel switching valve 34 and the coupling flange 48.

The nozzle 9 is provided in the middle of the intake path, particularly in the channel 18 downstream of the air compressor 3. The coupling flange 43 is provided on the periphery in an axially central portion of the nozzle 9.

A base end portion 51, which is to be connected to the air compressor 3 via an undepicted intake pipe, is provided upstream of the coupling flange 43. The base end portion 51 is disposed outside of the housing 7.

An end portion 52 to be disposed in the decompression chamber 8 is provided downstream of the coupling flange 43.

The inside of the housing 7 forms the decompression chamber 8 into which the axial end portion 52 of the nozzle 9 is to be plugged. The housing 7 has the introduction hole 10 that is opened toward the outside of the housing 7, and communicates between the second EGR channel 32 and the decompression chamber 8.

The decompression chamber 8 also serves as a mixing part that mixes the compressed air ejected from the nozzle 9 with the EGR gas drawn through the introduction hole 10.

The housing 7 has a diffuser 53 downstream of the decompression chamber 8. The diffuser 53 has a pressure-increasing portion 54 of which the inner diameter gradually increases toward an outlet opening 55 starting from a downstream end of the decompression chamber 8. The pressure-increasing portion 54 is a region that reduces flow velocity of the mixed gas of the compressed air and the EGR gas to increase pressure.

The end portion 52 of the nozzle 9 is disposed in an insertional manner within the decompression chamber 8 of the ejector 4. The end portion 52 has an outer-diameter equivalent portion 61 having a constant outer diameter in the axial direction, and an outer-diameter-gradually-varying portion 62 that is provided closer to the end than the outer-diameter equivalent portion 61.

The inner wall of the nozzle 9 forms an inner-diameter gradually-varying portion 63 that extends to the throttle portion 38 from an inner-diameter equivalent portion having the same inner diameter as that of the inlet opening 37, and an inner-diameter equivalent portion 64 having a constant inner diameter in the axial direction.

The inner peripheral surface of the inner-diameter gradually-varying portion 63 is formed as a conical taper surface the inner diameter of which gradually decreases to the throttle portion 38 from a starting point located on the inner periphery of the nozzle orifice 36. The inner-diameter equivalent portion 64 extends from the inner-diameter gradually-varying portion 63 to the end opening 39.

The outer-peripheral surface of the outer-diameter-gradually-varying portion 62 is formed as a conical taper surface having an outer diameter that gradually decreases from a starting point A of the outer-diameter-gradually-varying portion 62 located at a terminal of the outer-diameter equivalent portion 61 to an end peripheral edge B as an endpoint of the outer-diameter-gradually-varying portion 62.

The starting point A of the outer-diameter-gradually-varying portion 62 is located on the periphery of the end portion 52 of the nozzle 9. The starting point A is provided on an annular ridgeline between a cylindrical surface of the outer-diameter equivalent portion 61 and the conical taper surface of the outer-diameter-gradually-varying portion 62.

The end peripheral edge B of the outer-diameter-gradually-varying portion 62 is provided on the periphery of the end opening 39 of the nozzle 9. The end peripheral edge B is provided on an annular ridgeline between an annular end surface provided on an open peripheral edge of the end opening 39 and the conical taper surface of the outer-diameter-gradually-varying portion 62. A crossed axes angle of the annular end surface and the conical taper surface is an obtuse angle larger than a right angle.

The conical taper surface is a sloped surface sloped from the starting point A to the end peripheral edge B.

The outer-diameter-gradually-varying portion 62 is disposed at a position allowing at least partial view thereof through the introduction hole 10 from the outside of the housing 7. Specifically, the outer-diameter-gradually-varying portion 62 is disposed at a position allowing at least partial view thereof when the inside (nozzle 9) of the ejector 4 is viewed through the introduction hole 10 from the outside (radially outer side of the nozzle 9) of the ejector 4.

Extension lines L1 and L2 of the conical taper surface of the outer-diameter-gradually-varying portion 62 intersect with each other at a point O on the central axis of the ejector 4 before intersecting with the inner wall of the housing 7.

The starting point A of the outer-diameter-gradually-varying portion 62 is desirably provided at the end of an extension line L3 as an extension line of a hole wall surface of the introduction hole 10 of the housing 7.

### Functions of First Embodiment

The functions of the EGR system of the first embodiment are now briefly described with reference to FIGS. 1 to 7.

When an ignition switch is turned ON (IG•ON), the ECU first acquires sensor signals necessary for calculating an operating condition (engine information) of the engine E. The ECU controls actuators through current application based on the operating condition of the engine E and a program stored in ROM, the actuators being for the bypass valve 2, the air compressor 3, the throttle valve 5, the waste gate valve 22, the channel switching valve 34, and the EGR valve 35.

For example, a target EGR amount is set in correspondence to a sensor signal (fresh-air-flow amount signal) output from an air flow meter, a sensor signal (engine rotation signal) output from a crank angle sensor, a sensor signal (engine load signal) output from the accelerator opening sensor or the throttle opening sensor, and the like.

When the engine E is in an operating range of a low engine load and a low engine speed, the ECU closes the channel switching valve 34 and fully closes the EGR valve 35, thereby stops introduction of the EGR gas into fresh air. This stables combustion in each cylinder of the engine E.

If a driver presses an accelerator pedal to make a request to increase speed, the ECU fully closes the bypass valve 2 and turns ON the actuator for the air compressor 3. In addition, the ECU opens the channel switching valve 34, and fully closes the EGR valve 35. Consequently, the EGR gas is drawn into the intake path 20 through the exhaust path 15, the second EGR channel 32, and the channel 18.

When the engine E is in an operating range of a medium engine load and a medium engine speed, the ECU turns OFF the actuator for the air compressor 3, and fully opens the bypass valve 2. In addition, the ECU closes the channel switching valve 34. The ECU adjusts the opening of the EGR valve 35 in correspondence to the operating condition of the engine E.

When the engine E is in an operating range of a high engine load and a high engine speed, the ECU turns OFF the actuator for the air compressor 3, and fully opens the bypass valve 2. In addition, the ECU closes the channel switching valve 34, and fully closes the EGR valve 35. This allows a reduction in output of the engine E to be avoided.

When operation of the engine E is started, intake gas is drawn into the cylinder through the intake path 11, and exhaust air is exhausted from the cylinder through the exhaust path 15.

The turbine 16 of the turbo charger TC is rotationally driven by pressure (exhaust energy) of the exhaust air exhausted from the cylinder of the engine E.

When rotation of the turbine 16 is transmitted to the compressor 13 via the turbine shaft 17, the compressor 13 rotates.

When the compressor 13 rotates, fresh air passing through the air cleaner 1 is drawn by the compressor 13. When the channel switching valve 34 is closed while the EGR valve 35 is opened, the EGR gas flows into the first EGR channel 31 from the exhaust path 15 through the EGR cooler 33. The EGR gas flowing into the first EGR channel 31 is introduced into the intake path 11 upstream of the compressor 13. The EGR gas introduced into the intake path 11 is mixed with fresh air passing through the air cleaner 1, and is drawn by the compressor 13. While the EGR valve 35 is fully closed, only the fresh air is drawn by the compressor 13.

The fresh air or the fresh air plus the EGR gas drawn by the compressor 13 is compressed by the compressor 13, and is then sent to the intake path 12.

When the actuator for the air compressor 3 is turned OFF, and when the bypass valve 2 is fully opened, the fresh air or the fresh air plus the EGR gas is sent to the cylinder of the engine E through the intake path 12, the channel 19, and the intake path 20.

When the channel switching valve 34 is opened while the bypass valve 2 is fully closed, and when the actuator for the air compressor 3 is ON, the EGR gas flowing out from the turbine 16 into the exhaust path 15 flows into the second EGR channel 32 through the EGR cooler 33.

The EGR gas flowing into the second EGR channel 32 goes to the introduction hole 10 of the ejector 4 disposed downstream of the compressor 13.

At this time, when the actuator for the air compressor 3 is turned ON, the air compressed by the compressor 13 is further compressed, resulting in generation of compressed air having a pressure higher than the atmospheric pressure. The compressed air is introduced from the inlet opening 37 of the ejector 4 into the nozzle orifice 36 of the nozzle 9, and is decompressed by the throttle portion 38 so as to be formed into a high-speed air flow of the compressed air.

When the air flow of the compressed air is ejected into the decompression chamber 8 from the end opening 39 of the nozzle 9, negative pressure is generated in the decompression chamber 8. The negative pressure generated in the decompression chamber 8 allows the EGR gas to be drawn through the introduction hole 10 of the housing 7.

Pressure is increased by the diffuser 53 while the high-speed air flow of the compressed air is mixed with the EGR gas in the decompression chamber 8. The mixed gas of the compressed air and the EGR gas is sent from the outlet opening 55 of the housing 7 to the channel 18 downstream of the ejector 4.

The mixed gas is sent to the cylinder of the engine E through the channel 18 and the intake path 20.

### Effects of First Embodiment

As described above, in the EGR system of the first embodiment, the air compressor 3 that compresses air supplied from the compressor 13 to generate compressed air having a pressure higher than the atmospheric pressure, and the ejector 4 including the nozzle 9 that ejects the air flow of the compressed air supplied from the air compressor 3 are provided in the channel 18 downstream of the compressor 13 of the turbo charger TC. In other words, the ejector 4 is provided in the channel 18 downstream of the air compressor 3.

Consequently, since the compressed air having a pressure higher than the atmospheric pressure can be supplied from the air compressor 3 to the nozzle 9 of the ejector 4, the inlet pressure of the nozzle 9 can be increased to a pneumatic pressure higher than the atmospheric pressure.

The compressed air supplied from the air compressor 3 is ejected from the end opening 39 of the nozzle 9 into the decompression chamber 8. Negative pressure is generated in the decompression chamber 8 by the air flow of the compressed air ejected into the decompression chamber 8. The negative pressure allows the EGR gas to be drawn through the introduction hole 10 of the housing 7. The ejector 4 sends the EGR gas, which is drawn into the decompression chamber 8, to the cylinder of the engine E while mixing the EGR gas with the air flow of the compressed air that is ejected from the end opening 39 of the nozzle 9 into the decompression chamber 8.

This increases the amount of the EGR gas, which is drawn from the second EGR channel 32 into the channel 18 by the ejector effect, to a desired level or higher.

Hence, a larger amount of EGR gas can be drawn from the second EGR channel 32 into the channel 18, which makes it possible to increase the upper limit of the amount of EGR gas. Consequently, large contribution to the effect of improving fuel consumption can be expected.

The end portion 52 of the nozzle 9 has the outer-diameter-gradually-varying portion 62 having an outer diameter that gradually decreases from the starting point A to the end peripheral edge B. The outer-diameter-gradually-varying portion 62 of the nozzle 9 is disposed at a position allowing at least partial view thereof through the introduction hole 10 from the outside of the housing of the ejector 4.

Consequently, the EGR gas, which is introduced into the housing 7 through the introduction hole 10, is introduced into the decompression chamber 8 without colliding with the outer wall of the outer-diameter equivalent portion 61 of the nozzle 9. The outer-diameter-gradually-varying portion 62 guides the EGR gas from the introduction hole 10, and thus the EGR gas can be efficiently mixed with the air flow of the compressed air supplied from the air compressor 3. Consequently, the amount of the EGR gas can be extremely increased compared with existing techniques.

The extension lines L1 and L2 of the conical taper surface of the outer-diameter-gradually-varying portion 62 intersect with each other at a point O on the central axis of the ejector 4 before intersecting with the inner wall of the housing 7. The starting point A of the outer-diameter-gradually-varying portion 62 is provided at the end of the extension line L3 as an extension line of a hole wall surface C of the introduction hole 10 of the ejector 4. This can suppress a decrease in channel cross section of the channel for the EGR gas flow in the ejector, the EGR gas being introduced into the decompression chamber 8 through the introduction hole 10; hence, pressure loss in the EGR gas flow can be decreased.

When the EGR gas flow meets the air flow of the compressed air, no separation or vortex occurs in the EGR gas flow at the end peripheral edge B because a downstream end (end peripheral edge B) of the outer-diameter-gradually-varying portion 62 of the ejector 4 does not have a right angle. Consequently, an increase in pressure loss in the EGR gas flow can be suppressed.

It is therefore possible to reduce pressure loss or stagnation in the EGR gas flow due to collision with the outer wall of the outer-diameter equivalent portion 61 of the nozzle 9.

### Experimental Results of First Embodiment

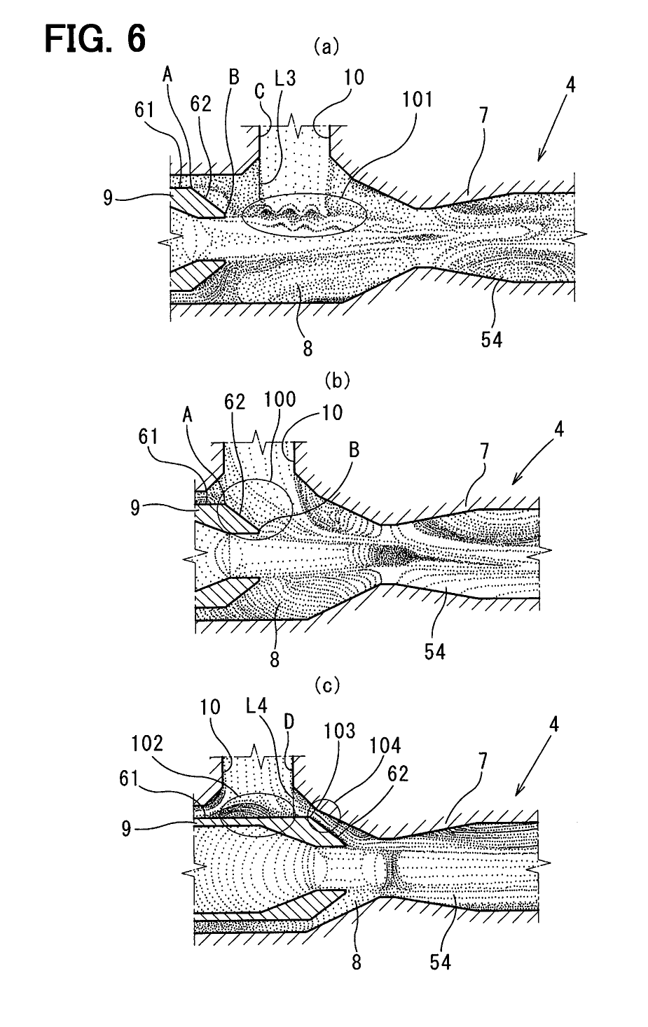

There is now described an experiment to investigate how EGR rate, i.e., EGR gas/(EGR gas+compressed air) is varied. The experiment is conducted through varying a position of the starting point A of the outer-diameter-gradually-varying portion 62. The starting point A corresponds to the endpoint of the outer-diameter equivalent portion 61 of the nozzle 9 as illustrated in FIG. 6.

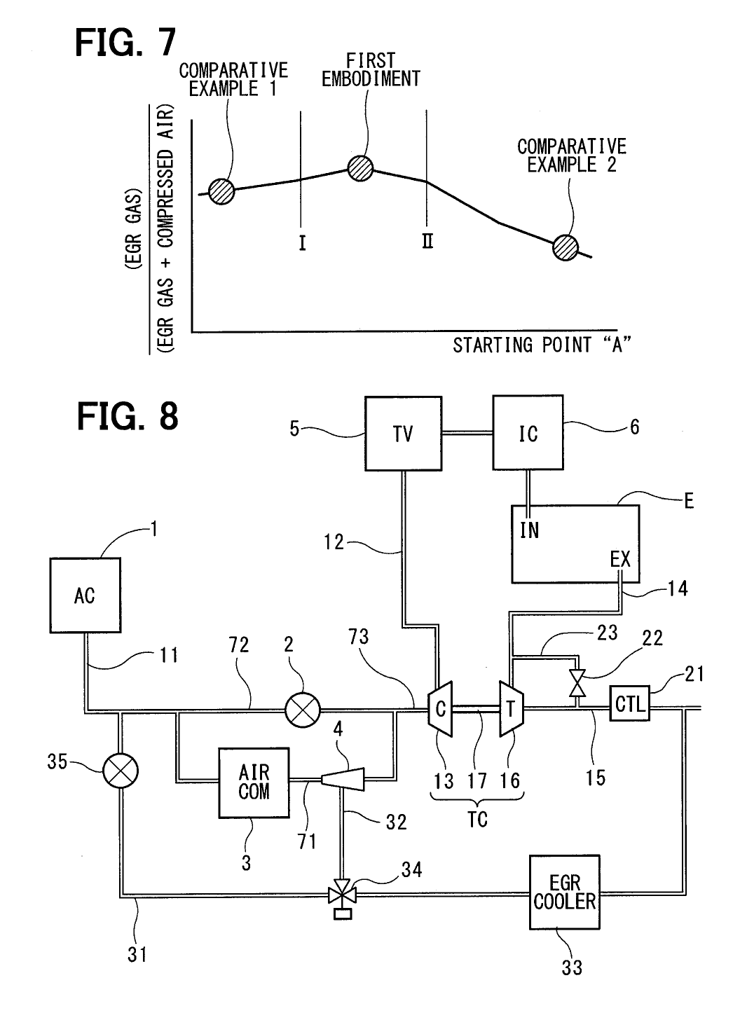

This experiment is conducted to investigate the EGR rate, i.e., EGR gas/(EGR gas+compressed air) through varying the position of the starting point A of the outer-diameter-gradually-varying portion 62 of the nozzle 9. The experimental results are shown in FIG. 6 and a graph of FIG. 7.

First, there is investigated an EGR rate when the outer-diameter-gradually-varying portion 62 of the nozzle 9 is at a position at which the outer-diameter-gradually-varying portion 62 is not viewed through the introduction hole 10 from the outside of the housing 7. FIG. 6(a) illustrates an ejector 4 of a first comparative example, in which the starting point A of the outer-diameter-gradually-varying portion 62 is disposed at a position illustratively leftward compared with the end of the extension line L3 as an extension line of the hole wall surface C of the introduction hole 10 of the ejector 4.

In such a case, as illustrated in FIG. 6(a), the air flow of the compressed air, which is ejected into the decompression chamber 8 from the end opening 39 of the nozzle 9, perpendicularly collides with the EGR gas flow drawn into the decompression chamber 8 through the introduction hole 10 (area 101); hence, turbulence occurs in the air flow of the compressed air and in the EGR gas flow. This reveals that if the nozzle 9 is located illustratively leftward, the EGR rate tends to be reduced as seen from the graph of FIG. 7.

Subsequently, there is investigated an EGR rate when the outer-diameter-gradually-varying portion 62 of the nozzle 9 is at a position at which the outer-diameter-gradually-varying portion 62 is not viewed through the introduction hole 10 from the outside of the housing 7. FIG. 6(c) illustrates an ejector 4 of a second comparative example, in which the starting point A of the outer-diameter-gradually-varying portion 62 is disposed at a position illustratively rightward compared with the end of an extension line L4 as an extension line of a hole wall surface D of the introduction hole 10 of the ejector 4.

In such a case, as illustrated in FIG. 6(c), the EGR gas flow, which is drawn into the decompression chamber 8 through the introduction hole 10, collides with the outer wall surface of the outer-diameter equivalent portion 61 that is viewed from the outside of the housing 7 through the introduction hole 10 (area 102); hence, stagnation occurs in the EGR gas flow.

In addition, since an edge 103 of the nozzle 9 is close to the inner wall of the housing 7, a throttle portion 104 is formed in the channel for the EGR gas flow in the ejector, the EGR gas being introduced into the decompression chamber 8 through the introduction hole 10. This decreases channel cross section of the channel in the ejector, leading to an increase in pressure loss in the EGR gas flow. As seen from the graph of FIG. 7, if the nozzle 9 protrudes illustratively rightward, the EGR rate tends to be reduced.

An EGR rate is investigated when the outer-diameter-gradually-varying portion 62 of the nozzle 9 is located at a position allowing at least partial view thereof through the introduction hole 10 from the outside of the housing 7. FIG. 6(b) illustrates an ejector 4 of the first embodiment, in which the outer-diameter-gradually-varying portion 62 of the nozzle 9 is disposed at a position allowing at least partial view thereof through the introduction hole 10 from the outside of the housing 7.

In such a case, as illustrated in FIG. 6(b), the EGR gas, which is introduced into the housing 7 through the introduction hole 10, is introduced into the decompression chamber 8 without colliding with the outer wall of the outer-diameter equivalent portion 61 of the nozzle 9. The outer-diameter-gradually-varying portion 62 of the nozzle 9 serves as a guide that efficiently mixes the EGR gas from the introduction hole 10 with the air flow of the compressed air, resulting in formation of a beautiful EGR gas flow (area 100). This reveals that when the outer-diameter-gradually-varying portion 62 of the nozzle 9 is located at a position allowing at least partial view thereof through the introduction hole 10 from the outside of the housing 7, the EGR rate tends to be good.

Hence, when the position of the starting point A of the outer-diameter-gradually-varying portion 62 is varied in the axial direction of the ejector 4 with respect to the hole wall surfaces C and D of the introduction hole 10 of the ejector 4, the amount of EGR gas, which can be introduced into the decompression chamber 8 of the ejector 4, is varied. Consequently, the starting point A of the outer-diameter-gradually-varying portion 62 of the nozzle 9 is set at the optimum position with respect to the hole wall surfaces C and D of the introduction hole 10, leading to efficient introduction (drawing) of a large amount of EGR gas.

The position allowing at least part of the outer-diameter-gradually-varying portion 62 of the nozzle 9 to be viewed through the introduction hole 10 from the outside of the housing 7 refers to a position at which the starting point A or the end peripheral edge B of the outer-diameter-gradually-varying portion 62 is disposed between the hole wall surfaces C and D of the introduction hole 10 of the ejector 4. In other words, one of the starting point A and the end peripheral edge B of the outer-diameter-gradually-varying portion 62 should be disposed at a position (for example, a range from I to II in the graph of FIG. 7) allowing view thereof through the introduction hole 10 from the outside of the housing 7.

### Configuration of Second Embodiment

FIG. 8 illustrates a second embodiment to which the disclosure is applied.

The same numeral as in the first embodiment indicates the same configuration or function, and is thus not described.

An intake pipe of the second embodiment is provided with the air cleaner 1, the bypass valve 2, the air compressor 3, the ejector 4, the compressor 13, the throttle valve 5, and the intercooler 6.

The intake path 11 downstream of the air cleaner 1 is bifurcated into first and second intake paths (channels 71 and 72) at a bifurcation. The channels 71 and 72 meat at a joint upstream of the compressor 13, and communicate with an intake path 73 upstream of the compressor 13. A downstream end of the compressor 13 communicates with the intake path 12 upstream of an intake manifold.

The bypass valve 2 is provided in the middle of the channel 72. The opening of the bypass valve 2 is adjusted by controlling an electromotive actuator through current application by the ECU. This allows adjustment of flow rate of an air flow that bypasses the channel 71 as in the first embodiment. Consequently, flow rate of EGR gas drawn by the ejector 4 can be adjusted.

The channel 71 is disposed in parallel with the channel 72. The channel 71 communicates between the intake path 11 downstream of the air cleaner 1 and the intake path 73.

The channel 72 communicates between the intake path 11 and the intake path 73 without passing through the air compressor 3 and the ejector 4.

The air compressor 3 is provided in the channel 71 upstream of the compressor 13 and of the ejector 4. The air compressor 3 is rotationally driven by an electromotive actuator.

The ejector 4 is provided in the channel 71 upstream of the compressor 13.

In this way, the EGR system of the second embodiment exhibits the effects similar to those of the first embodiment.

[Modification]

Although the first or second embodiment has been described with an exemplary case where the turbo charger TC, which uses exhaust pressure of an internal combustion engine (engine) to compress and supercharge intake air supplied to a combustion chamber of each cylinder of the internal combustion engine (engine), is used as a super charger, an electromotive (assist supercharging) turbo charger TC, which uses driving force of an electromotive motor to drive the turbine 16 and the compressor 13, may be used as the supercharger.

A multi-cylinder diesel engine or a multi-cylinder gasoline engine may be used as the internal combustion engine. Not only the multi-cylinder engine but also a single-cylinder engine may be used as the internal combustion engine.

The EGR system may further include “high-pressure loop (HPL)-EGR system” in addition to “LPL-EGR system”.

In the first or second embodiment, the nozzle outer-peripheral surface, which ranges from the starting point A to the end peripheral edge B as an endpoint of the outer-diameter-gradually-varying portion 62, is formed to be a conical taper surface sloped by a predetermined slope angle with respect to the axial direction of the nozzle 9. However, the nozzle outer-peripheral surface, which ranges from the starting point A to the end peripheral edge B of the outer-diameter-gradually-varying portion 62, may be formed to be a convex or concave surface having an outer diameter that gradually decreases from the starting point A to the end peripheral edge B.

Although an electromotive supercharger such as, for example, an electromotive supercharger or an electromotive compressor is used as the air compressor 3 in the first or second embodiment, the compressor of the turbo charger TC may be used as the air compressor 3.

An engine-drive supercharger may also be used as the air compressor 3. In such a case, a clutch mechanism such as an electromagnetic clutch may be provided between the crank shaft of the engine E and an axle shaft of the supercharger. This makes it possible to switch between transmission and interruption of power from the engine E to the supercharger.

It is understood that while the disclosure has been described in accordance with embodiments, the disclosure is not limited to such embodiments or structures. The disclosure also includes various modifications and variations within the equivalent scope. In addition, various combinations and modes, and other combinations and modes containing only one, not less than one, or not more than one additional element are also included in the category or the idea scope of the disclosure.

1. An exhaust circulating device for an internal combustion engine, comprising:
an EGR channel that returns EGR gas from an exhaust path to an intake path of an internal combustion engine;
a tubular nozzle into which air is introduced through the intake path;
a negative-pressure generation chamber that uses negative pressure generated by an air flow ejected from an end opening of the nozzle to draw the EGR gas, an end portion of the nozzle being disposed in an insertional manner in the negative-pressure generation chamber;
an ejector that supplies the EGR gas drawn into the negative-pressure generation chamber to the internal combustion engine while mixing the EGR gas with the air flow ejected into the negative-pressure generation chamber; and
an air compressor that compresses air containing at least outside air to generate compressed air, and supplies the compressed air to the nozzle,
wherein the ejector has an introduction hole that is opened toward the outside of the ejector, and communicates between the EGR channel and the negative-pressure generation chamber,
the nozzle has an outer-diameter-gradually-varying portion having an outer diameter that gradually decreases from a starting point located on periphery of the end portion of the nozzle to an end peripheral edge provided on periphery of the end opening, and
the outer-diameter-gradually-varying portion is disposed at a position allowing at least part of the outer-diameter-gradually-varying portion to be viewed through the introduction hole from the outside of the ejector.

2. The exhaust circulating device for an internal combustion engine according to claim 1,
wherein the outer-diameter-gradually-varying portion has a conical taper surface sloped from a starting point of the outer-diameter-gradually-varying portion to the end peripheral edge, and
extension lines of the conical taper surface intersect with each other at a point on a central axis of the ejector before intersecting with an inner wall of the ejector.

3. The exhaust circulating device for an internal combustion engine according to claim 1, wherein the starting point of the outer-diameter-gradually-varying portion is provided at the end of an extension line of a hole wall surface of the introduction hole.

4. The exhaust circulating device for an internal combustion engine according to claim 1, further comprising
a turbo charger including a turbine provided in the exhaust path of the internal combustion engine, and a compressor provided in the intake path of the internal combustion engine,
wherein the air compressor is provided in the intake path downstream of the compressor.

5. The exhaust circulating device for an internal combustion engine according to claim 4,
wherein the intake path has a bypass channel that communicates between the intake path upstream of the air compressor and the intake path downstream of the ejector, and bypasses the air compressor and the ejector, and
the intake path has a bypass valve that opens or closes the bypass channel.

6. The exhaust circulating device for an internal combustion engine according to claim 1, further comprising
a turbo charger including a turbine provided in the exhaust path of the internal combustion engine, and a compressor provided in the intake path of the internal combustion engine,
wherein the air compressor is provided in the intake path upstream of the compressor.

7. The exhaust circulating device for an internal combustion engine according to claim 6,
wherein the intake path has a bypass channel that communicates between the intake path upstream of the air compressor and the intake path downstream of the ejector, and bypasses the air compressor and the ejector, and
the intake path has a bypass valve that opens or closes the bypass channel.
